(19) United States
(12) Patent Application Publication
(10) Pub. No.: US 2019/0205608 A1
(43) Pub. Date: Jul. 4, 2019

(54) METHOD AND APPARATUS FOR SAFETY MONITORING OF A BODY OF WATER

(71) Applicant: Deep Innovations Ltd, London (GB)

(72) Inventor: Samuel Weitzman, London (GB)

(21) Appl. No.: 16/226,644

(22) Filed: Dec. 20, 2018

Related U.S. Application Data
(60) Provisional application No. 62/611,549, filed on Dec. 29, 2017.

(51) Int. Cl. G06K 9/00; G06N 3/08; G08B 21/08

(52) U.S. Cl. CPC G06K 9/0061; G06N 3/08; G06K 9/00248; G08B 21/086; G06K 9/00288; G06K 9/00604; G06K 9/00617; G06K 9/00281

(57) ABSTRACT

Systems and methods for the safety monitoring of a body of water. The system comprises one or more image capturing units mounted outside a body of water and overlooking the area of the body of water, as well as a processing unit enabling real-time detection and tracking of objects. The processing can be performed either on the actual image capturing unit, a network video recorder device or on a cloud device. The system utilizes deep learning algorithms, including artificial neural networks, that perform video analytics using a method comprising the following steps:
a. the areas of interest around the body of water are defined upon initial set up of the system; in a man-made body of water, the area surrounding the pool would be defined as Area 1 and the pool itself would be defined as Area 2; in the context of the ocean, such interest areas are the beach area, ocean and any other pre-defined areas;
b. in each frame the system extracts features and uses the deep learning, algorithms to identify if the image consists of a person and/or object defined by the system; this analysis is performed in real-time with no time delay;
c. the system recognizes and distinguishes between different types of objects, as well as stationary objects;
d. the identification and classification of each object is then cross referenced with the specific location of the object as recognized by the system and the areas of interest as outlined in point a above.

### CROSS-REFERENCE TO RELATED APPLICATIONS

This application claims the benefit of provisional application U.S. 62/611,549.

The entire content of that application is hereby incorporated by reference.

### BACKGROUND

The background description includes information that may be useful in understanding the present invention. It is not an admission that any of the information provided herein is prior art or relevant to the presently claimed invention, or that any publication specifically or implicitly referenced is prior art.

The present disclosure relates to video analytics. Video analytics currently

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

The following description includes information that may be useful in understanding the present invention. It is not an admission that any of the information provided herein is prior art or relevant to the presently claimed invention, or that any publication specifically or implicitly referenced is prior art.

In some embodiments, the numbers expressing quantities of ingredients, properties

Such as concentration, reaction conditions, and so forth, used to describe and claim certain embodiments of the invention are to be understood as being modified in some instances by the term “about.”

Accordingly, in some embodiments, the numerical parameters set forth in the written description and attached claims are approximations that can vary depending upon the desired properties sought to be obtained by a particular embodiment.

In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable.

The numerical values presented in some embodiments of the invention may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “Such as’) provided with respect to certain embodiments herein is intended merely to better illuminate the invention and does not pose a limitation on the scope of the invention otherwise claimed.

No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### SUMMARY

The present invention provides video analytics software that analyzes real-time video feed from a video camera unit overlooking a body of water (swimming pool, Jacuzzi, spa, ocean, etc.) to actively monitor and primarily reduce drowning events. The present invention can automatically detect, track and distinguish between an adult, child, toddler, or the family dog. The advanced analytics ensure that only specific events, such as an unsupervised toddler approaching the pool or a person drowning are flagged.

Processing of the images are performed on a computer processor which is located either in the cloud or on a processor imbedded in the camera unit. The system uses unique neural networks created using deep learning technologies to identify such objects and events in real-time.

The present invention provides a detection and tracking system for use in and around water-related environments (pool, sea, jacuzzi, etc) comprising: one or more image capturing unit mounted outside the body of water and overlooking the area of the body of water, comprises a processing unit enabling real-time detection and tracking of objects; wherein said processing can be performed either on the actual image capturing unit, a network video recorder device or on a cloud device.

The present invention uses deep learning algorithms (such as artificial neural networks) that perform video analytics using a method comprising the following steps:

a. The areas of interest around the body of water are defined upon initial set up of the system. For example in a man-made body of water (i.e. Jacuzzi, swimming pool) the area surrounding the pool would be defined as Area 1 and the pool itself would be defined as Area 2. In the context of the Ocean, such interest areas could be the beach area, Ocean or any other pre-defined area.

b. In each frame the system extracts features and uses the deep learning algorithms to identify if the image consists of a person and/or object defined by the system. This analysis is performed in real-time with no time delay.

c. Recognize and distinguish between different types of objects such as an adult, child, toddler, dog, cat, etc as well as stationary objects like a beach ball inside a body of water.

d. The identification and classification of each object is then cross referenced with the specific location of the object as recognized by the system and the areas of interest as outlined in point a above.

The present invention provides a detection and tracking method comprising the following steps:

a. Identification and classification of objects in and around the area of a body of water using deep learning algorithms (such as artificial neural network).

b. Track each said object in real-time while counting how many objects are visible in the defined area of interest, which is primarily areas in and around the body of water.

c. Identify if one or more objects are missing for more than a defined period of time in a specific area of interest.

d. Report a suspected event to the user.

In yet another aspect, the detection and tracking method comprises the following steps:

a. Identification of a family member using deep learning algorithms;

b. Using image data from sources made available to the system which include (but not limited to) social media, digital family photo albums and information retained by the system.

c. The present invention uses a system that learns over time how each user looks like, how they act in the swimming pool and how long they typically stay in and around the pool area.

d. Report a suspected event to the user if any abnormal activity is identified.

The present invention uses a system capable of self-learning to personally identify individual persons and figures over time, determine which behavior marks a hazardous situation (without the need to pre-setup) and identify ages and identity of allowed and un-allowed persons that use the pool.

Self-learning capabilities provide flexibility and a user specific operation. These personal matching abilities can assist in achieving a more reliable hazard and drowning detection. The self-learning identification ability can be used to detect and alarm in a presence of an intruder or under age user while avoiding false alarms when an authorized person is using the body of water.

The following description and drawings are directed to the facial recognition aspect of the present invention.

### BRIEF DESCRIPTION OF DRAWINGS

FIG. 1 is a diagram of the areas of interest in the example of a swimming pool and positioning of the camera unit for the purpose of image capturing.

FIG. 2 is a diagram of the major steps performed by the face verification system in accordance with a preferred embodiment of the present invention.

FIG. 3 is a diagram of the major steps involved in deriving a facial image bounding box in accordance with the present invention.

FIG. 4 is a diagram of the major steps involved in locating the eyes in a facial image in accordance with the present invention.

FIG. 5 is a diagram showing additional details of the process of selecting weights in accordance with the present invention.

### DETAILED DESCRIPTION OF THE PREFERRED EMBODIMENTS

The present invention is a system, method and application for the recognition, verification and similarity ranking of facial or other object patterns. While the techniques of the present invention have many applications in the general area of object recognition, they are particularly well suited to the task of face recognition. This task poses numerous difficulties particularly where many variations can be expected in the appearance of the facial image to be recognized. The techniques of the present invention result in a system which can verify a match between two facial images where significant differences may occur between the images.

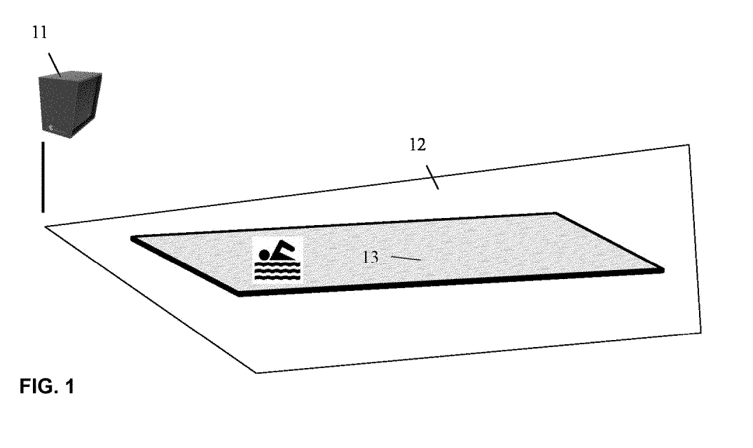

A camera unit is positioned overlooking the body of water and the surrounding area as shown in FIG. 1. Upon set-up of the system boundaries between areas of interest are defined. These are shown in FIG. 1 as number 12 for the area in the vicinity of the pool and number 13 for the pool area itself. Additional areas of interest may be defined by the user. The use-case for this ability is not limited to any specific type of body of water and includes both man-made and natural bodies of water.

The camera unit 11 acquires an image of the objects in its field of view that could include for example individuals in a swimming pool. The camera produces an image which includes, for example, the entire head and shoulders of the individual. In accordance with a process described in more detail below, this image is adaptively clipped to include just the immediate area of the individual's face to yield a clip which is the same size as the reference image.

This clip image is then transferred to an automated face locator 26 which performs the function of registering the position and orientation of the face in the image. In accordance with a technique which will be described in more detail below, in the preferred embodiment of the present invention the location of the face is determined in two phases. First, the clip image 22 is found by defining a bounding box, resulting in image 24. The location of the bounding box is based on a number of features. Second, the location of the individual's eyes is determined. Once the location of the eyes is determined, the face is rotated about an axis located at the midpoint (gaze point) between the eyes to achieve a precise vertical alignment of the two eyes. The purpose of the automated face locator 26 is to achieve a relatively precise alignment of the test image 24 with the reference image 16. It will be appreciated that an automated face locator 26 will also be used to locate the face in the test image 16. It should be noted that the adaptive automated face locator 26 is needed to locate the face in the test and reference image 16, because with standard (nonadaptive) image processing techniques, the derived outline of the face will necessarily include the outline of the hair. However in accordance with the present invention the clip image 24 defined by the bounding box will not include the hair.

In any event, it is important that the resulting test image 28 be accurately registered with respect to the reference image. That is, in accordance with the preferred embodiment described in more detail below an accurate location of the eyes is determined for the reference image and an accurate location for the eyes is determined for the test image 24. The two images are then registered so that the location of the midpoint between both eyes are registered in both images. This is important because the automated face verifier 18 will be attempting to determine whether the two images are those of the same person. If the two images are misregistered, it is more likely to incorrectly determine that the two images of the same person are from different persons because similar features will not be aligned with similar features.

The automated face verifier receives the clipped and registered reference image and test image 28 and makes a determination of whether the persons depicted in the two images are the same or are different. This determination is made using a neural network which has been previously trained on numerous faces to make this determination. However, once trained, the automated face verifier is able to make the verification determination without having actually been exposed to the face of the individual.

Initially a test image 22 and a reference image 30 are acquired. These images are then both processed by a clip processor 32 which defines the bounding box containing predetermined portions of each face. It will be appreciated that, in general, the reference prerecorded image may be stored in various ways. The entire image of the previous facial image may be recorded as shown in the image 30 in FIG. 2, or only a previously derived clip may be stored. Also, a clip that is compressed in a compression method for storage may be stored which is then decompressed from storage for use. In addition, some other parameterization of the clip may be stored and accessed later to reduce the amount of storage capacity required. Alternatively, the prerecorded image may be stored in a database as discussed above.

The reference and test images 22, 30 are then dipped. This occurs in two stages. First, a coarse location is found in step 33. This yields the coarse location of the image shown in Blocks 23 and 24. Next, a first neural network 26 is used to find a precise bounding box shown in Blocks 28 and 29. In a preferred embodiment the region of this bounding box 28 is defined vertically to be from just below the chin to just above the natural hair line (or implied natural hair line if the person is bald). The horizontal region of the face in this clipping region is defined to be between the beginning of the ears at the back of the cheek on both sides of the face. If one ear is not visible because the face is turned at an angle, the clipping region is defined to be the edge of the cheek or nose, whichever is more extreme. This process performed by chip processor 32 will be described in more detail below in connection with FIG. 3.

Next, a second neural network 30 is used to locate the eyes. The image is then rotated in step 34 about a gaze point as described in more detail in FIG. 4. The above steps are repeated for both the reference and the test images. The two images are then registered in step 88, using the position of the eyes as reference points.

Next, the registered images are normalized in step 90. This includes normalizing each feature value by the mean of all the feature values. It should be noted that the components of the input image vectors represent a measure of a feature at a certain location, and these components comprises continuous valued numbers.

Next, a third neural network 38 is used to perform the verification of the match or mismatch between the two faces 22, 30. First, weights are assigned in block 36, as described in more detail connected with in FIG. 5. It should be noted that the location of the weights and features are registered. Once the weight assignments are made the appropriate weights in the neural network 38 are selected. The assigned reference weights comprise a first weight vector 40 and the assigned test weights comprise a second weight vector 42. The neural network 38 then determines a normalized dot product of the first weight vector and the second weight vector in block 44. This is a dot product of vectors on the unit circle in N dimensioned space, wherein each weight vector is first normalized relative to its length. A well-known technique for normalizing such vectors is used in vector quantization, which is commonly used in connection with Kohonen neural networks. For further details with respect to normalization and related Kohonen neural networks see Wasserman, Neural Computing Theory and Practice, Van Nostrand Reinhold (1989). pp. 63-71 and pp. 201-209 which is incorporated in its entirety herein by reference.

The result is a number which is the output 46 of the neural network 38. This output is then compared to a threshold in decision step 48. Above threshold outputs indicate a match 50 and below threshold outputs indicate a mismatch 52.

The above process will now be described in more detail. Referring to FIG. 3, the clip process 32 is shown. An acquired image 54 may comprise either the test or the reference image. This image includes the face of the subject as well as additional portions such as the neck and the shoulders and also will include background clutter. An image subtraction process is performed in accordance with conventional techniques to subtract the background. For example, an image of the background without the face 56 is acquired. The image of the face and background is then subtracted from the background (block 58). The result is the facial image without the background 60. In step 61 standard, non-adaptive edge detection image processing techniques are used to determine a very coarse location of the silhouette of the face. It is coarse because this outline is affected by hair, clothing, etc.

Next the image is scaled down, for example, by a factor of 20 (block 62). This would reduce a 100 pixel by 80 pixel image down to 5×5. The image is then scaled down. For example, the total resulting image may include the following scales: 5×5, 6×6, 7×7, 10×10, 12×12, 16×16 and 18×18. This results in a hierarchy of resolutions. With regard to scaling it should be noted that the convolution types and sizes are identical for all images at all scales; and because they are identical, if the images are first scaled down to have coarsely scaled inputs then the convolutions will yield a measure of more coarse features. Conversely, if higher resolution inputs are used (with the same size and type kernel convolution) then the convolution will yield finer resolution features.

Thus, the scaling process results in a plurality of features at different sizes. Accordingly, the next step is to perform a convolution on the scaled image in block 64. For example this may be a 3×3 convolution. In the preferred embodiment the convolutions used have zero-sum kernel coefficients. Also, a plurality of distributions of coefficients are used in order to achieve a plurality of different feature types. These may include, for example, a center surround, or vertical or horizontal bars, etc. This results in different feature types at each different scale. Steps 62 and 64 are then repeated for a plurality of scales and convolution kernels. This results in a feature space set 66 composed of a number of scales (“S”) a number of features (“F”) based on a number of kernels (“K”). This feature space then becomes the input to a neural network 68. In the preferred embodiment this comprises a conventional single layer linear proportional neural network which has been trained to produce as output the coordinates of the four corners of the desired bounding box 72 when given the facial outline image as input.

A description of a neural network suitable for this purpose may be found in the article, M. Kuperstein, “Neural Model of Adaptive Hand-eye Coordination For Single Postures”, SCIENCE Vol. 239 pp. 1308-1311 (1988), which is herein incorporated by reference. Optionally, a hierarchical approach may be employed in which the feature space is transformed by a series of neural networks into bounding boxes that are increasingly closer to the desired bounding box. That is, the first time through the first neural network the output is a bounding box which is slightly smaller than the perimeter of the image and that box is clipped out and the features redefined and put into another neural network that has an output which is a bounding box that is a little closer to the desired bounding box. By repeating this process interactively until the final desired bounding box achieved, it has been found that the amount of noise with each iteration was reduced and the result is a more stable convergence to the desired bounding box with each neural network. Adequate results have been achieved in this manner with a hierarchy of two neural networks. In the preferred embodiment weights in the neural network 33 are assigned according to the techniques shown in FIG. 5 and discussed below.

Referring now to FIG. 4, the process of locating the face 26 within the bounding box is shown. The general approach of the present invention is to locate with some precision a given feature on the face and register the corresponding features in the reference and test images before performing the comparison process. In the preferred embodiment the feature used is the eyes. It will be appreciated that the eyes can be difficult to locate because of various factors such as reflections of light from glasses, from the eyes themselves, variations in shadows, etc. Further, the size of the eyes, their height, and other factors are all unknown. Because of this, an adaptive neural network is used to find the location of each of the eyes.

In more detail, first, the data outside the bounding box in feature space 66 (shown in FIG. 3) is eliminated. This feature space 72 (shown in FIG. 4) is input into a neural network 74 which has been trained to generate the x coordinate point of a single point, referred to as the “mean gaze”. The mean is defined as the mean position along the horizontal axis between the two eyes. That is, the x position of the left and right eye are added together and divided by two to derive the mean gaze position. The neural network 74 may comprise one similar to the neural network 68 shown in FIG. 3, This neural net 74 is trained with known faces in various orientations to generate as output the location of the mean gaze. In the preferred embodiment weights in the neural network 74 are assigned according to the technique shown in FIG. 5 and discussed below.

Once the mean gaze is determined 76, a determination is made of which of five bands along the horizontal axis the gaze falls into. That is, a number of categories of where the gaze occurs are created. For example, these categories may determine whether the gaze occurred relatively within the middle or relatively in the next outer band, or in a third outer band of the total width of the face. These bands are not necessarily of equal width. For example, the center band may be the thinnest, the next outer ones a little wider and the final ones the widest. Wherever the computed mean gaze is located on the x coordinate will determine which band it falls into (step 78). Further, this will determine which of five neural networks will be used to find the location of the eyes. (step 80) Next, the feature set is input to the selected neural network in step 82. This neural network has been trained to determine the x and y coordinates of eyes having the mean gaze in the selected band 84.

The use of a plurality of neural networks for the different bands has the effect of making the inputs to each of the networks with respect to themselves much more similar. This is important because of the highly variable appearance of faces depending on whether the gaze is forward, leftward or rightward. By the use of a hierarchy of neural networks which each correspond to a certain range of the gaze of the face the inputs to each of the networks with respect to themselves are much more similar.

Next, the entire face is rotated (in two dimensions) about the gaze point until the x and y position of the eyes are level on the horizontal axis in step 86. The gaze point becomes a reference point for registration of the test and reference images as indicated in step 88 in FIG. 2.

Next, the feature sets are normalized 90 (shown in FIG. 2). This is accomplished by, for example, normalizing each feature value by the mean amplitude of all feature values. This normalization process normalizes against variations such as lighting conditions so that the feature set used in the neural network can withstand varying contrast or lighting conditions.

Next, in step 36 (in FIG. 2) the feature values are assigned to weights in the neural network 38. The preferred approach (for neural network 38, as well as for neural networks 26 and 30) will be to quantize the feature values from an analog number to a quantum number that is positive or negative. This is done by taking the whole range of values of all sets and quantize the range by certain ratios of twice the mean (positive and negative). Next, the positive feature value are ranked and the negative feature values are ranked with respect to their values. A set of positive ranks and a set of negative ranks are thereby defined. For a given feature value it can be assigned to a bin that is quantized by ranking the values. In the preferred embodiment this is done by defining the ranks by the fractions ⅓ and ½. In particular, all of the elements in the input vector (which comprises both positive and negative numbers) are used to determine their positive mean and their negative mean. For example, twice the positive mean may be 1000 and twice the negative mean may be 1500. Applying the fractions of ⅓ and ½ to 1000 would equal 333 and 500. Thus the first rank would equal components from 0333 the second rank between 334-500 and the third rank would be components greater than 500. Next, all the individual components of the input vector are placed in one of the three ranks based on their value. The same process is also performed for the negative components in the feature vectors,

Next, each ranked component value is assigned a weight based on its rank. This process of assigning weights is described in more detail in FIG. 5. There are 6 bins, each bin corresponding to a weight. There are 3 negative and 3 positive bins throughout the total range of component values of −800 through +800. A four by four weight lookup table vector 92 is shown which contains 16 components of the feature vectors. For example, one of these components is 600, another is 400, another is −100. Also, a four by four weight vector 94 is depicted. Each of the 16 weight locations in the four by four weight vector 94 correspond to one of the 16 components of the feature vector. Each location in the weight vector has six different weights corresponding to six different ranks.

In this example, there are three positive ranks and three negative ranks. As described above, each component in the feature vector is ranked. For example, 400 is determined to be of rank five, thus this component is mapped to the 5th of six weights within the corresponding location in the four by four weight vector 94. Similarly, the component having a value of 600 is put into the 6th rank and accordingly this feature vector is assigned to the weight value which exists in the third rank of its corresponding location of weight vector 94. The component having a value of −100 is assigned to the 2nd rank.

This process is repeated for all of the components of the feature vector. In an actual image, however, the feature vector may have many more components. There may be, for example, 10,000 components in the feature vector.

It should be noted that some components of feature vector may have a value of zero. When features values equal zero the system can decide to put these values in a bin or not. This decision is made differently for different neural networks. For the networks used to locate the bounding box 26 and the eyes 30, feature values of zero are not used. However, for the matching neural network 38 feature values of zero are used for weights associations. This is because with the bounding box or the eyes the output of the neural net is a coordinate value and it is not desirable to have a non-feature contribute to the location of an x,y point. However, when the feature value for the face verification neural network 38 is zero, it is desirable to have that contribute to the result. For example, in a face, the absence of a feature (zero feature value) is an important indicator of a mismatch, whereas the absence of a feature is not important to locate the bounding box or the eyes. A non-zero value for a feature vector component means that a feature has been measured at that location while a zero indicated that no feature has been measured at that location.

It should also be noted that the actual values of the selected weights in the vector are adaptive and will be modified during training as described in more detail below.

Also, the exact weight chosen in the weight vector will depend on the preexisting value of that weight vector component. However, there is a fixed relationship between each location in the feature vector and the corresponding location in the weight vector (each of which has multiple weights, one for each rank).

Once the weight vector 94 has been determined for both the reference set and test feature set the neural network 38 computes the normalized dot product of the two weight vectors. In essence, this operation computes the sum of the products of corresponding elements of the two weight vectors. This is operation 44 shown in FIG. 2. It will be appreciated that the dot product output will be a number which is proportional to the similarity between the two weight vectors. That is, highly similar weight vectors are more parallel and will yield higher dot product outputs indicating that the faces are similar. Dissimilar weight vectors will yield lower valued dot product outputs indicating that the faces are less similar.

The fact that the dot product operation is a “normalized” dot product means that the dot product of the output 46 is normalized to the unit circle in N dimensional space. The normalization process is performed by dividing the dot product by the product of each of the vector lengths. The normalized dot product results in a confidence level and that confidence level is normalized by a linear transformation constant to get the range needed, i.e., 0-10 or 0-100. If the confidence measure is above a preset verification threshold then the result is “positive”. This means that the face in the test clip 32 depicts a face belonging to the same person as that in the reference clip 33. If the value is not above the predetermined threshold the result is “negative,” which means that the test clip 33 and reference clip 32 depict faces of different people.

The procedure for training the neural network 38 to correctly perform the face matching procedure will now be described. Initially all of the weights are set to zero.

When two training facial images are input into the system, since all the weight values are zero the resulting dot product of the two weight vectors will also be zero. Because this is training data however it is known whether the two faces are from the same person or not. If they are from the same person then it is desired to have the result be a relatively high valued positive number. This is because matching feature vectors should produce above threshold outputs. The threshold may be selected arbitrarily to be at the midrange. When the two faces are from the same person, a starting positive value is selected and the two weight vectors are made to be the same positive value. If the two faces are from a different people then each weight value is given opposite assigned values, one starting value is positive and one is a negative but equal value.

Subsequently the neural network will be trained on many examples of pairs of faces, some of which match, and some of which do not match. A variety of faces in a variety of orientations and lighting conditions will be used to allow the neural network to generalize all of this information. As a result it will be able to recognize when two different views of the same person are actually the same person, and when two images of different people are in fact faces of different people.

The learning algorithm used in the preferred embodiment is as follows:

1. If the output 46 is correct make no changes to the weights. That is, a correct result means that two faces that are the same generate an output which is above threshold, and two faces which are from different persons generate an output that is below threshold.

2. If the result is negative (below threshold) and incorrect, adapt corresponding weights and weight vectors 1 and 2 to be closer to each other. The amount of adjustment is preferably a percentage of the difference between the two weights. This percentage is the learning rate for the adaptation. It should be noted that only weights which are selected by the feature sets 1 and 2 are adapted; non-selected weights are not. As discussed above, if both weight values are zero, (as in the initial condition) both weight values are changed to be a preset constant value.

3. If the output 46 is positive (above threshold) and incorrect, adapt the corresponding weights in weight vectors 1 and 2 to be farther from each other. Again, the amount of adjustment is a percentage of their difference. Only weights which are selected by the feature sets are adapted. If both the weight values are zero, the weight value of weight set 1 is set to the same preset constant value used in training step 2 above. However, the weight value from weight set 2 is set to the negative of this value.

The test images should comprise of pairs of randomly selected images of faces. Also, images of the same person should be used approximately half the time and images of different persons should be used about half the time. The objective of training is to give the system enough training with different orientations and different head postures etc. so it will be able to generalize across different head orientation and head postures. Thus, the training example will include examples of a head looking straight, to the left, to the right, up and down.

For example, the system may be trained with images of 300 different people in different orientations. It is being trained not to recognize any specific face but instead it is being trained to recognize what is similar about different images of the same face. It is being trained to be a generalized face recognizer as opposed to being able to recognize any specific face.

In a preferred embodiment, hysteresis is used during learning. This means that to avoid learning the result must be above or below the threshold by a given amount. For example, if two test images are from the same face, and the threshold is defined as an output of 5 on a scale of 0 to 10, then to avoid learning the output must be 5+delta. Thus any output less than the threshold of 5+delta will cause the system to adapt weights to be closer to each other. In this way, only results which are less ambiguously correct will avoid learning. Results which are correct, but only slightly above threshold will be further refined by additional training.

Likewise, when the system is trained with two training images of different faces, in order to avoid adaptation of the weights, the result must be below threshold by a given amount, for example below 5 minus delta. As a result any output above 5 minus delta will result in adaptation of the weights to produce less ambiguous results. In a preferred embodiment the delta amount used for the learning hysteresis may be 0.5. It should be remembered that this hysteresis is only used during the training procedure and not during actual use of the system on unknown faces. Thus, in actual use, where it is not known beforehand whether the faces match or not, any above threshold output will be considered to be a match and any result which is at or below threshold will be considered to be no match. It should be noted that the weights are always associated with a certain location in the neural network 38 and a certain feature of the neural network. However, every face is different so every image that comes from a different face will pick up different weights. But the weights themselves are always associate with a certain location and with a certain feature even though which weights are actually picked up depends on which face is being processed. As a result, the entire neural network will begin to average over all faces it has ever seen in its experience.

It should also be noted that the operations of the neural network 38 in accordance with the present invention is quite different from the prior techniques, such as the self-organizing maps of Kohonen as described, for example in the article R. Lippman, An Introduction to Computing with Neural Networks”. IEEE ASSP Magazine, April 1987, pp 4-2, which is incorporated by reference. Those skilled in the art will appreciate that with the Kohonen method a dot product is taken between a single input and the weight vector in the neural network. The weight vector which generates the highest dot product is designated the “winner” and that weight vector is modified during training to be even closer to the input vector.

In contrast, in the present invention two inputs operate on the neural network simultaneously instead of just one. Further, in the present invention, each input vector selects weights in the neural network and the dot product between each of the two selected weight vectors is determined. During learning, in the present invention, both sets of weight vectors are adapted to be closer to each other or farther apart from each other. Thus it is important to recognize that the architectural and learning algorithm of the present invention are specifically adapted to perform a comparison between two inputs, unlike Kohonen network which is adapted to classify an input into one of several outputs or associate an input with an output. The Kohonen network does not perform the function of comparing the similarity between two inputs. Also, in the present invention the actual feature vector is never used in the dot product as its in Kohonen networks. In the present invention only weights are used in the dot product operation. Also in the Kohonen system initially the weights are set to random values; in the present invention weights are initially set to zero.

Another advantage of the present invention is that it can be trained to generate a high matching value for incompatible looking objects. This is a major advantage over prior art approaches to face recognition. For example, suppose input vectors one and two representing facial images were identical. If a dot product is performed on the two images and they are identical, the result would be very high. However, if the images are offset by even one or two pixels then the dot product will be very low because everything is misregistered. In contrast, with the technique of the present invention the system can be trained to generate a matching output for different appearing objects. For example, if the input images were of an apple and an orange each image would select weight vectors and those weight vectors would be trained on various images of apples and oranges to generate a high dot product value. Yet a dot product between the raw image of the apple and orange would yield a very low value.

This malleable nature of the present invention is important because the human face varies tremendously whenever the orientation and lighting etc. of the face is changed. The present invention achieves the goal of being able to match images that are in some ways incompatible. This approach works because it defers the dot product operation to a reference of the inputs (the weight vectors) and does not perform the dot product on the raw image.

Of course, there are limits as to how variable the inputs can be even with the present invention. If input images vary too widely the training process will average weights according too wide a variability and the results will be unsatisfactory. This is why it is important to reliably produce the registration of the images; for example by achieving a very good location of a particular feature (for example, the eyes). If instead this feature is mislocated the faces will be misregistered and the results will be less reliable.

Further, while the preferred embodiment employs neural networks to perform verification, other adaptive processors could be used including, but not limited to, genetic algorithms, fuzzy logic, etc. In general adaptive processors are those which can perform facial verification for faces that vary by head orientation, lighting conditions, facial expression, etc., without having explicit knowledge of these variations. Thus, one could substitute another type of adaptive processor for the neural network in the present invention.

It will also be appreciated by those skilled in the art that all of the functions of the present invention can be implemented by suitable computer programming techniques. Also, it will be appreciated that the techniques discussed above have applications outside facial recognition and matching.

1. A detection and tracking system for use in and around water-related environments comprising:
one or more image capturing units mounted outside a body of water and overlooking the area of the body of water,
a processing unit enabling real-time detection and tracking of objects;
wherein the processing can be performed either on the actual image capturing unit, a network video recorder device or on a cloud device;
wherein the processing utilizes deep learning algorithms, including artificial neural networks, that perform video analytics using a method comprising the following steps:
a. the areas of interest around the body of water are defined upon initial set up of the system; in a man-made body of water, the area surrounding the pool would be defined as Area 1 and the pool itself would be defined as Area 2; in the context of the ocean, such interest areas are the beach area, ocean and any other pre-defined areas;
b. in each frame the system extracts features and uses the deep learning algorithms to identify if the image consists of a person and/or object defined by the system; this analysis is performed in real-time with no time delay;
c. the system recognizes and distinguishes between different types of objects, as well as stationary objects;
d. the identification and classification of each object is then cross referenced with the specific location of the object as recognized by the system and the areas of interest as outlined in point a above.

2. The system of claim 1 that uses a system capable of self-learning to personally identify individual persons and figures over time, determine which behavior marks a hazardous situation, without the need to pre-setup, and identify ages and identity of allowed and un-allowed persons that use the pool.

3. The system of claim 1 further comprising:
self-learning capabilities that provide flexibility and a user specific operation;
the self-learning identification capability can be used to detect and sound the alarm in the presence of an intruder or under age user while avoiding false alarms when an authorized person is using the body of water.

4. The system of claim 1, further comprising:
a camera unit positioned overlooking the body of water and the surrounding area;
wherein the boundaries between areas of interest are defined;
one boundary is the area in the vicinity of the pool;
another boundary is for the pool area itself;
additional areas of interest may be defined by the user;
the camera unit acquires an image of the objects in the camera unit's field of view that includes individuals in a swimming pool;
the camera unit produces an image which includes the entire head and shoulders of each individual;
this image is adaptively clipped to include just the immediate area of the individual's face to yield a clip which is the same size as a reference image;
this clip image is then transferred to an automated face locator which performs the function of registering the position and orientation of the face in the image;
the location of the face is determined in two phases:
first, the clip image is found by defining a bounding box, resulting in a bounding box based image;
Second, the location of the individual's eyes is determined;
Once the location of the eyes is determined, the face is rotated about an axis located at the midpoint (gaze point) between the eyes to achieve a precise vertical alignment of the two eyes;
this results in the automated face locator having a relatively precise alignment of the test image with the reference image;
then the automated face locator will be used to locate the face in the test image;
the clip image defined by the bounding box will not include the hair.

5. The system of claim 4, further comprising:
an accurate location of the eyes is determined for the reference image and an accurate location for the eyes is determined for the test image;
the reference image and test image are then registered so that the location of the midpoint between both eyes are registered in both the reference image and test image;
the automated face verifier then attempts to determine whether the reference image and the test image are those of the same person.

6. The system of claim 1, further comprising:
An automated face verifier receives a clipped and registered reference image and a test image and makes a determination of whether the persons depicted in the two images are the same or are different;
this determination is made using a neural network which has been previously trained on numerous faces to make this determination;
once trained, the automated face verifier is able to make the verification determination without having actually been exposed to the face of the individual whose face is being verified.

7. The system of claim 6, further comprising:
a test image and a reference image are acquired;
these images are then both processed by a clip processor which defines the bounding box containing predetermined portions of each face;
the reference prerecorded image may be stored in various ways;
i) either the entire image of the previous facial image may be recorded
ii) or only a previously derived clip may be stored;
iii) or a clip that is compressed in a compression method for storage may be stored which is then decompressed from storage for use;
iv) or some other parameterization of the clip may be stored and accessed later to reduce the amount of storage capacity required
v) or the prerecorded image may be stored in a database;
then the reference and test images are clipped, this occurs in two stages:
first, a coarse location of the silhouette of a face is found;
next, a first neural network is used to find a precise bounding box;
the region of this bounding box is defined vertically to be from just below the chin to just above the natural hair line, or implied natural hair line if the person is bald;
the horizontal region of the face in this clipping region is defined to be between the beginning of the ears at the back of the cheek on both sides of the face;
if one ear is not visible because the face is turned, at an angle, the clipping region is defined to be the edge of the cheek or nose, whichever is more extreme;
this process performed by a chip processor;
next, a second neural network is used to locate the eyes;
the resulting image of the eyes is then rotated about a gaze point;
the above steps are repeated for both the reference and the test images;
the two images are then registered using the position of the eyes as reference points.

8. The system of claim 7, further comprising:
the registered images are normalized;
this includes normalizing each feature value by the mean of all the feature values;
the components of the input image vectors represent a measure of a feature at a certain location, and these components comprise continuous valued numbers;
next, a third neural network is used to perform the verification of the match or mismatch between the two faces;
first, weights are assigned;
the location of the weights and features are registered;
once the weight assignments are made the appropriate weights in the neural network are selected;
the assigned reference weights comprise a first weight vector and the assigned test weights comprise a second weight vector;
the neural network then determines a normalized dot product of the first weight vector and the second weight vector;
this is a dot product of vectors on the unit circle in N dimensioned space, wherein each weight vector is first normalized relative to its length;
the result is a number which is the output of the neural network;
this output is then compared to threshold outputs;
above the threshold outputs indicate a match and below threshold outputs indicate a mismatch.

9. The system of claim 1, further comprising:
an acquired image may comprise either the test or the reference image;
this image includes the face of the subject as well as additional portions such as the neck and the shoulders and also will include background clutter;
an image subtraction process is performed to subtract the background;
an image of the background without the face is acquired;
the image of the face and background is then subtracted from the background;
the result is the facial image without the background;
then non-adaptive edge detection image processing techniques are used to determine a very coarse location of the silhouette of the face;
next the image is scaled down by a factor of 20;
this results in a hierarchy of resolutions;
if the images are first scaled down to have coarsely scaled inputs then the convolutions will yield a measure of more coarse features;
conversely, if higher resolution inputs are used with the same size and type kernel convolution then the convolution will yield finer resolution features;
thus, the scaling process results in a plurality of features at different sizes;
the next step is to perform a convolution on the scaled image;
the convolutions used have zero-sum kernel coefficients;
a plurality of distributions of coefficients are used in order to achieve a plurality of different feature types, including a center surround, vertical and/or horizontal bars;
this results in different feature types at each different scale;
then repeated for a plurality of scales and convolution kernels.
this results in a feature space set composed of a number of scales, a number of features, based on a number of kernels;
this feature space then becomes the input to a neural network;
this comprises a conventional single layer linear proportional neural network which has been trained to produce as output the coordinates of the four corners of the desired bounding box when given a facial outline image as input.

10. The system of claim 9, further comprising:
the processing unit locating with some precision a given feature on the face and registering the corresponding features in the reference and test images before performing the comparison process;
wherein the feature used is the eyes;
wherein an adaptive neural network is used to find the location of each of the eyes;
first, the data outside the bounding box resulting from the feature space is eliminated;
this feature space is input into a neural network, which has been trained to generate the x coordinate point of a single point, referred to as the “mean gaze”; the mean is defined as the mean position along the horizontal axis between the two eyes;
the x position of the left and right eye are added together and divided by two to derive the mean gaze position;
the neural network is trained with known faces in various orientations to generate as output the location of the mean gaze;
once the mean gaze is determined, a determination is made of which of five bands along the horizontal axis the gaze falls into;
a number of categories of where the gaze occurs are created;
wherever the computed mean gaze is located on the x coordinate will determine which band it falls into;
this will determine which of five neural networks will be used to find the location of the eyes;
next, the feature set is input to the selected neural network;
this neural network has been trained to determine the x and y coordinates of eyes having the mean gaze in the selected band.

11. A detection and tracking method comprising the following steps:
a. identifying and classifying of objects in and around the area of a body of water using deep learning algorithms, including an artificial neural network;
b. tracking each said object in real-time while counting how many objects are visible in the defined area of interest, which is primarily areas in and around the body of water;
c. identifying if one or more objects are missing for more than a defined period of time in a specific area of interest;
d. reporting a suspected event to the user.

12. The method of claim 11 that uses a system capable of self-learning to personally identify individual persons and, figures over time, determine which behavior marks a hazardous situation, without the need to pre-setup, and identify ages and identity of allowed and un-allowed persons that use the pool.

13. The method of claim 11 further comprising:
self-learning capabilities providing flexibility and a user specific operation;
the self-learning identification capability being used to detect and sound the alarm in the presence of an intruder or under age user while avoiding false alarms when an authorized person is using the body of water.

14. The method of claim 11, further comprising:
a camera unit positioned overlooking the body of water and the surrounding area;
wherein the boundaries between areas of interest are defined;
one boundary is the area in the vicinity of the pool;
another boundary is for the pool area itself;
additional areas of interest may be defined by the user;
the camera unit acquiring an image of the objects in the camera unit's field of view that includes individuals in a swimming pool;
the camera unit producing an image which includes the entire head and shoulders of each individual;
this image is adaptively clipped to include just the immediate area of the individual's face to yield a clip which is the same size as a reference image;
this clip image is then transferred to an automated face locator which performs the function of registering the position and orientation of the face in the image;
the location of the face is determined in two phases:
first, the clip image is found by defining a bounding box, resulting in a bounding box based image;
Second, the location of the individual's eyes is determined;
Once the location of the eyes is determined, the face is rotated about an axis located at the midpoint (gaze point) between the eyes to achieve a precise vertical alignment of the two eyes;
this results in the automated face locator having a relatively precise alignment of the test image with the reference image;
then the automated face locator will be used to locate the face in the test image;
the clip image defined by the bounding box will not include the hair.

15. The method of claim 14, further comprising:
an accurate location of the eyes is determined for the reference image and an accurate location for the eyes is determined for the test image;
the reference image and test image are then registered so that the location of the midpoint between both eyes are registered in both the reference image and test image;
the automated face verifier then attempts to determine whether the reference image and the test image are those of the same person.

16. The method of claim 11, further comprising:
an automated face verifier receiving a clipped and registered reference image and a test image and making a determination of whether the persons depicted in the two images are the same or are different;
this determination is made using a neural network which has been previously trained on numerous faces to make this determination;
once trained, the automated face verifier is able to make the verification determination without having actually been exposed to the face of the individual whose face is being verified.

17. The method of claim 16, further comprising:
a test image and a reference image are acquired;
these images are then both processed by a clip processor which defines the bounding box containing predetermined portions of each face;
the reference prerecorded image may be stored in various ways;
i) either the entire image of the previous facial image may be recorded
ii) or only a previously derived clip may be stored;
iii) or a clip that is compressed in a compression method for storage may be stored which is then decompressed from storage for use;
iv) or some other parameterization of the clip may be stored and accessed later to reduce the amount of storage capacity required
v) or the prerecorded image may be stored in a database;
then the reference and test images are clipped, this occurs in two stages:
first, a coarse location of the silhouette of a face is found;
next, a first neural network is used to find a precise bounding box;
the region of this bounding box is defined vertically to be from just below the chin to just above the natural hair line, or implied natural hair line if the person is bald;
the horizontal region of the face in this clipping region is defined to be between the beginning of the ears at the back of the cheek on both sides of the face;
if one ear is, not visible because the face is, turned at an angle, the clipping region is defined to be the edge of the cheek or nose, whichever is more extreme;
this process performed by a chip processor;
next, a second neural network is used to locate the eyes;
the resulting image of the eyes is then rotated about a gaze point;
the above steps are repeated for both the reference and the test images;
the two images are then registered using the position of the eyes as reference points.

18. The method of claim 17, further comprising:
the registered images are normalized;
this includes normalizing each feature value by the mean of all the feature values;
the components of the input image vectors represent a measure of a feature at a certain location, and these components comprise continuous valued numbers;
next, a third neural network is used to perform the verification of the match or mismatch between the two faces;
first, weights are assigned;
the location of the weights and features are registered;
once the weight assignments are made the appropriate weights in the neural network are selected;
the assigned reference weights comprise a first weight vector and the assigned test weights comprise a second weight vector;
the neural network then determines a normalized dot product of the first weight vector and the second weight vector;
this is a dot product of vectors on the unit circle in N dimensioned space, wherein each weight vector is first normalized relative to its length;
the result is a number which is the output of the neural network;
this output is then compared to threshold outputs;
above the threshold outputs indicate a match and below threshold outputs indicate a mismatch.

19. The method of claim 11, further comprising:
an acquired image may comprise either the test or the reference image;
this image includes the face of the subject, as well as additional portions such as the neck and the shoulders and also will include background clutter;
an image subtraction process is performed to subtract the background;
an image of the background without the face is acquired;
the image of the face and background is then subtracted from the background;
the result is the facial image without the background;
then non-adaptive edge detection image processing techniques are used to determine a very coarse location of the silhouette of the face;
next the image is scaled down by a factor of 20;
this results in a hierarchy of resolutions;
if the images are first scaled down to have coarsely scaled inputs then the convolutions will yield a measure of more coarse features;
conversely, if higher resolution inputs are used with the same size and type kernel convolution then the convolution will yield finer resolution features;
thus, the scaling process results in a plurality of features at different sizes;
the next step is to perform a convolution on the scaled image;
the convolutions used have zero-sum kernel coefficients;
a plurality of distributions of coefficients are used in order to achieve a plurality of different feature types, including a center surround, vertical and/or horizontal bars;
this results in different feature types at each different scale;
then repeated for a plurality of scales and convolution kernels.
this results in a feature space set composed of a number of scales, a number of features, based on a number of kernels;
this feature space then becomes the input to a neural network;
this comprises a conventional single layer linear proportional neural network which has been trained to produce as output the coordinates of the four corners of the desired bounding box when given a facial outline image as input.

20. A detection and tracking method comprising the following steps:
a. identifying of a family member using deep learning algorithms;
b. using image data from sources made available to a system and information retained by the system, including social media and digital photos;
c. using the system that learns over time how each user looks like, how they act in the swimming pool and how long users typically stay in and around the pool area;
d. reporting a suspected event to the user if any abnormal activity is identified.
